(19) United States
(12) Patent Application Publication
(10) Pub. No.: US 2013/0173572 A1
(43) Pub. Date: Jul. 4, 2013

(54) LEVERAGING AFFILIATIONS TO PROVIDE SEARCH RESULTS

(71) Applicants: Lawrence Colagiovanni, Issaquah, WA (US); Arun Sacheti, Sammamish, WA (US); Marcelo De Barros, Redmond, WA (US); Nektarios Ioannides, Bellevue, WA (US); Mikhail Parakhin, Redmond, WA (US); Meenaz Merchant, Sammamish, WA (US)

(72) Inventors: Lawrence Colagiovanni, Issaquah, WA (US); Arun Sacheti, Sammamish, WA (US); Marcelo De Barros, Redmond, WA (US); Nektarios Ioannides, Bellevue, WA (US); Mikhail Parakhin, Redmond, WA (US); Meenaz Merchant, Sammamish, WA (US)

(73) Assignee: MICROSOFT CORPORATION, Redmond, WA (US)

(21) Appl. No.: 13/341,856

(22) Filed: Dec. 30, 2011

(51) Int. Cl. G06F 17/30

(52) U.S. Cl. 707/706; 707/769; 707/E17.108

(57) ABSTRACT

Information from social networks may be used to identify a user's interests and predilections, and the information may be used to affect search results. In one example, social networks have pages that correspond to real entities, such as manufacturers and merchants. Entity pages in social networks are mapped to their corresponding real entities, and information that users leave on the pages (e.g., “likes”, or textual reviews) are extracted to determine users' sentiments about the entities. When users search for products with a search engine, user sentiment is then used to guide the results. Social networks' information about users (e.g., their affinities, such as schools, workplaces, interests) may be used to determine the relevance of specific users' sentiments—e.g., sentiments of users who went to a particular school may be used to influence search results, when the search is requested by someone who went to the same school.

### BACKGROUND

Social networks contain large amounts of information about products, stores, brands, or other information that is relevant to purchase decisions. For example, a car manufacturer might have a page on a social network, such as Facebook. Users might “like” particular vehicle models posted on the car manufacturer's page, or might leave text comments about a specific model of car. This type of information may be relevant to people who are making purchase decisions.

While data gathered through social networks may contain the raw materials to help others make purchase decisions, the large amount of data on social networks makes these data difficult to use. Hundreds or thousands of people might leave comments about a particular retailer, brand of car, or model of computer. For a prospective purchaser to use the comments effectively, the user would have to read through all of the comments, figure out what the community's overall sentiment is, figure out whether a given comment is influenced by the commenter's background or taste, and perform various other tasks to understand and digest the data.

### SUMMARY

Data that is relevant to purchases may be mined from social networks, and the mined information may be used to choose which products to suggest to a given user.

Social networks typically have pages that correspond to entities, such as merchants, brands, or products. Some of these pages are official pages, while others are unofficial pages maintained by users unrelated to a particular merchant or brand. Any of the pages may draw comments or other activity from users of the social network. In order to use data created on these pages, a mapping is created between pages in the social network and real entities. For example, on Facebook there might be an official Microsoft page, and several unofficial Microsoft pages maintained by users of Microsoft products. These pages may be analyzed to identify the real entity (i.e., Microsoft Corporation) to which the pages refer, and a mapping between social network pages and real entities or products may be created.

Once the mapping has been created, the sentiments expressed, toward the entities or products, by users of the social network may be mined. For example, if a page exists for a particular computer manufacturer or a particular model of computer, then actions such as “like”, or comments such as “this computer is great” or “this computer broke after one use” may be analyzed. The analysis may indicate whether users generally like or dislike the target of the comments, and how strongly. These sentiments about products may be catalogued. The record of these sentiments may associate the sentiments with the users who provided them. E.g., one user might like the computer while the other does not; the specific sentiment associated with a particular user may be recorded.

The sentiments about entities or products may be used, along with information about a user's relationship to other users in a social graph, to influence search results. For example, if a user performs a product search for a computer, the search engine may choose or elevate computers that were favored by people who are perceived to be similar to the user who requested the search. For example, the search engine might focus on the sentiments of people who went to the same school as the requesting user, or who work for the same employer, or who have the same interests. The rules that are used to define similarity might be shown to the user who requested the search, and the user might opt out of certain rules. For example, the user might be told that the search results have been influenced to favor products that were well-liked by people who went to the user's school, or who work at his office. The user might believe that school affiliation is more significant than workplace affiliation, and thus might opt out of the rule that uses workplace affiliation to affect results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which information from a social network may be leveraged to affect or influence search results.

FIG. 2 is a flow diagram of an example process in which sentiments may be directed toward entities.

FIG. 3 is a flow diagram of an example process in which a search engine uses sentiments of users to affect or influence search results.

FIG. 4 is a block diagram of an example system in which sentiments may be extracted and used to affect search results.

FIG. 5 is a block diagram of example components that may be used in connection with implementations of the subject matter described herein.

### DETAILED DESCRIPTION

Social networks provide an opportunity to collects information that is relevant to purchases and other commercial transactions. Manufacturers, merchants, and individual products typically have their own pages in social networks such as Facebook. Additionally, users may create unofficial pages for entities or products. Users of the social network may “like” the pages or leave comments, thereby providing indications of their sentiments about entities and products. “Liking” a page on Facebook is a fairly clear indication of a user's favorable sentiment. However, unstructured expressions of opinion in the form of text may also give an indication of sentiment. While no shortage of user sentiment exists on social networks, finding information that is helpful in making purchase decisions often involves wading through large amounts of information. Some users have bias, background, or perspectives that might make their opinions unhelpful to a particular purchaser. Moreover, finding the various places in which the comments are located can be challenging—e.g., finding opinions about Microsoft products might involve looking at comments on the Microsoft official page, as well as any unofficial Microsoft pages.

The subject matter described herein provides techniques for marshaling opinions from social network, and using those opinions to help a particular user make purchasing decisions. In order to marshal the information, pages and other information on a social network may be analyzed to determine which pages are associated with real entities. For example, the official Microsoft page on Facebook, as well as various unofficial pages maintained by users of Microsoft products, might be mapped to the real entity “Microsoft Corporation.” Similarly, on Twitter it might be determined that the hashtags #MICROSOFT and #MSFT map to the entity Microsoft. Analysis of this information may yield a mapping between pages (or tags, or other information) in a social network, and real entities such as companies, manufacturers, stores, products, etc.

In addition to creating the mapping, sentiment information expressed on the social network may be mined. For example, if a user “likes” the page for a particular model of car on Facebook, this act tends to indicate that the user has a favorable sentiment toward the car. “Like” is an example of structured information that can be mined, although unstructured information such as text comments can also be mined. For example, comments such as “this computer is great”, “this car gets terrible gas mileage,” or “this store has the rudest salespeople” can be analyzed to determine whether a user tends to like, or to dislike, the computer, car, or store in question. Once the sentiments have been extracted, the mapping between pages and entities may be used to connect particular sentiments with particular entities. Sentiments may be stored anonymously in the aggregate, or the sentiments may be stored in a way that associates a particular sentiment with a particular person. (In order to protect a user's expectation of privacy, appropriate permission could be obtained before storing a user's sentiment in a non-anonymous way.)

When a user requests a product search, the search engine may use sentiment information obtained from a social network to affect and influence the search results. In one example, aggregate sentiments toward a product may be used to raise or lower the products position in the search results. For example, if a product, or its manufacturer, received generally favorable reviews on a social network, then the product may have its position raised in the search results. Conversely, negative sentiments toward a product or manufacturer may results in a product having its position lowered. In addition to using general sentiments about an entity, a system may also use sentiments expressed by people who are perceived to have some similarity to the user who requests the search. For example, if a user requests reviews of computers, the search engine might leverage information in a social graph to find out which users are perceived as having tastes similar to those of the user requesting the search. Users having similar taste might be those having a low social distance to the requesting user, or those who attended the same school as the user, or those who work for the same employer, or those who have expressed similar interests.

When search results are being affected by people's sentiments, the user could be shown the rules that govern how the search results are affected. For example, if a user's search results are being influenced by the sentiments of people who went to the same school as the user, the user could be shown this rule and could be given a chance to opt-out of the rule. (The user might not think that school affiliation has anything to do with which products the user would want to buy.) If the user opts out of the rule, then a search engine that provides the search results may cease to apply the rule—e.g., by providing new search results that are not affected or influenced by the opinions of people who have the same school affiliation as the user.

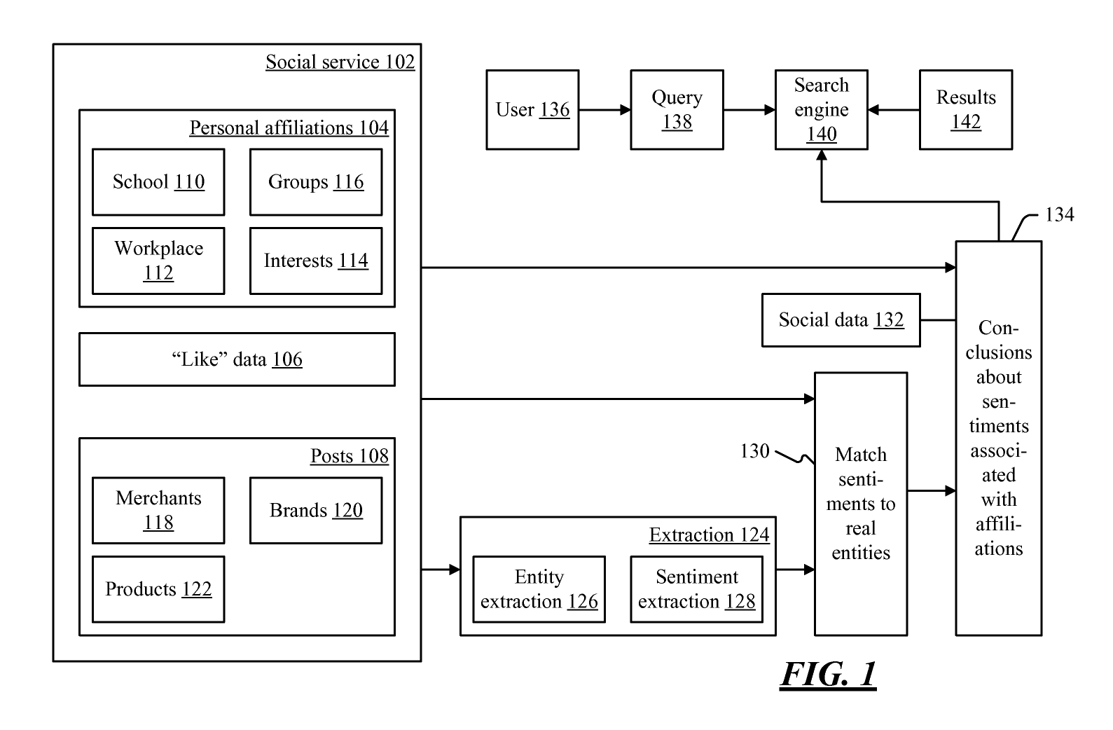

Turning now to the drawings, FIG. 1 shows an example scenario in which information from a social network may be leveraged to affect or influence search results. Social service 102 is a service that provides social-networking-type functions. Such functions may include communication between users (e.g., in the form of posts or private messages), and the ability for users to specify relationships with other users. For example, Facebook provides mutual “friend” relationships, and Twitter provides unidirectional “following” relationships, both of which are examples of relationships between users. Social service 102 may also provide features such as entity pages, where entities may be businesses, brands, specific products, etc. People may be able to leave comments relating to entities on social service 102. Facebook, Twitter, LinkedIn, etc., are examples of social service 102.

Social service 102 may marshal various types of information. Some examples of information that may be collected by a social network include personal affiliations 104, “like” data 106, and posts 108.

Personal affiliations 104 are characteristics of the people who participate in the social network. For example, personal affiliations may include school affiliations 110, workplace affiliations 112, interests 114, and groups 116. School affiliations 110 are the schools that a user has attended in the past, or is currently attending. Workplace affiliations 112 are the employers whom the user has worked for in the past, or is currently working for. Interests 114 are interests that have been self-reported by the user, or that may have been inferred from the user's behavior. Cycling, modern art, Japanese food, travel, etc., are examples of interests that might be catalogued by social service 102. Groups 116 are collections of users that may be recognized by social service 102. For example, social service may have groups relating to political parties, specific professions (e.g., attorneys), hobbies (e.g., flint knapping), or any other concept or activity around which people might coalesce. Social service 102 may allow its users to join these groups.

“Like” data 106 identifies entities to which users have explicitly applied a “like” function. Facebook's “like” function (which is specifically named “like”) is one example of such a function. However, other social services may employ similar concepts under different names. In effect, a “like” function is one in which a user can express a specific sentiment toward something in a single, structured action, rather than in a free-form way such as leaving a text comment. (It is noted that the sentiment expressed does not have to be favorable; if a social network were to provide buttons for “no opinion”, “so-so”, or “dislike” sentiments, those buttons would also constitute “like” functions for the purpose of the subject matter herein.) “Like” data 106 may be referred to herein as a “flag.” In general, in a situation where a user expresses a sentiment in response to a discrete choice (e.g., the choice to click, or not to click, a “like” button, or a choice of n possible sentiments such as “good”, “bad”, and “don't care”), the user's expression of the choice may be referred to as a flag.

Posts 108 are free-form, unstructured comments that users may make. Those comments may relate to a specific entity. For example, merchants 118, brands 120, and products 122 are examples of entities. These entities may maintain pages within social service 102. A user may leave information about these entities by posting comments on the pages. For example, a particular car manufacturer might have a page on social service 102, and a user might leave comments saying what be thinks of that brand of car. Or, a particular “big box” store (which is an example of a merchant) might have a page on social service 102, and a user might leave comments about his or her experience with that store. Or a computer manufacturer might have a page on social service 102 for a particular model of laptop or tablet, and users might leave comments saying what they think of that model. The comments in the foregoing examples are posts that might be made about specific entities. It is noted that a model of product, a brand, a manufacturer, and a merchant are examples of entities that could be the targets of posts, although any appropriate object could be an entity for the purpose of being a target of a post. It is also noted that posts and “likes” may be made on pages that are maintained by social service 102, although sentiments could be expressed in other places. For example, a Facebook user might post on his own wall that he does (or does not) like that merchant. Or, social service 102 might have a way of recognizing the existence of pages outside of social service 102—e.g., the XYZ computer manufacturer might have a page outside of social service 102 that users can like, or that they can cite in posts.

Because the information contained in posts 108 is unstructured (or partially unstructured), an extraction process 124 may be applied to that information to impose a structure on the information. For example, an entity extraction process 126 may be applied to identify the real entity to which a page, a tag, or any other identifier relates. For example, a car manufacturer might have an official page on social service 102, but owners of that brand of car might set up unofficial pages relating to the same brand of car. Both the official page and the unofficial page(s) may provide information about user sentiments, since users could post their sentiments (or apply a “like” function) to either type of page. Moreover, on service such as Twitter where entities are identified by hashtags, the specific hashtags that are used often develop organically based on usage, and these tags are unofficial. Thus, entity extraction process 126 may be used to associate various indications of entities (e.g., pages, hashtags, etc.) with real entities (as in the case of associating the various Microsoft pages on Facebook with the real entity Microsoft Corporation). Additionally, a sentiment extraction process 128 may be used to determine the sentiments that users express in the form of unstructured textual data. For example, phrases such as “This car is great,” “This computer froze after one use,” or “This tablet is okay” can be analyzed to identify the sentiment being expressed. (In one example, specific words such as “great” and “okay” are associated with particular sentiments. Words such as “froze” can be analyzed through a more complex process—e.g., “froze” might indicate a good sentiment when applied to meat freezers, but a bad sentiment when applied to computers, so the surrounding words might be taken into account when such terms are encountered.)

Thus, “like” data 106 and sentiments extracted from comments are both sources of sentiments about entities. Using this data (combined with the analysis described above that matches various indicia of entities with real entities), it is possible to create a match between expressed sentiments and real entities (block 130). For example, such a match might result in contain data such as “Joe likes the XYZ123 model of tablet,” or “Susan likes ABC Retail Stores,” or “Steve does not like cars made by PQR Motors” (where the XYZ123 table, ABC Retail Stores, and PQR Motors will be understood to be “real” entities).

Social data 132 may be a set of data that described people's affiliations within social service 102. For example, social data 132 may describe who is friends with whom, who follows whom, who went to which school, who works for which employer, who has certain hobbies, etc. By combining social data 132 with the matches between sentiments and entities described at block 130, it is possible to draw conclusions about sentiments associated with affiliations (block 134). For example, if one uses social data 132 to identify all of the people who went to Stanford University, then—using the information described at block 130—it is possible to determine the prevailing sentiment that people who went to Stanford University hold about the XYZ123 model of tablet. That is, one can use social data 132 to determine who went to Stanford, and can then use the information in block 130 to determine what those people think of the XYZ123 tablet. This conclusion about Stanford graduates' opinions of the tablet is then a conclusion that is included in block 134. This type of information can be used to affect or influence search results. For example, if user 136 enters query 138 into a search engine 140, the search engine 140 may use the conclusions described at block 134 to influence or affect the results provided to user 136. If user 136 enters a query for tablet computers, and if user 136 went to Stanford University, and if people who went to Stanford University tend to have positive sentiments toward the XYZ123 tablet, then search engine 140 may list the XYZ123 tablet higher on the results 142 than it would have listed that tablet if the query had come from someone who did not go to Stanford University. Similar influencing of results can be done based on workplace affiliation, interests, groups, or any other way in which people might be inferred from social data 132 to have similar tastes.

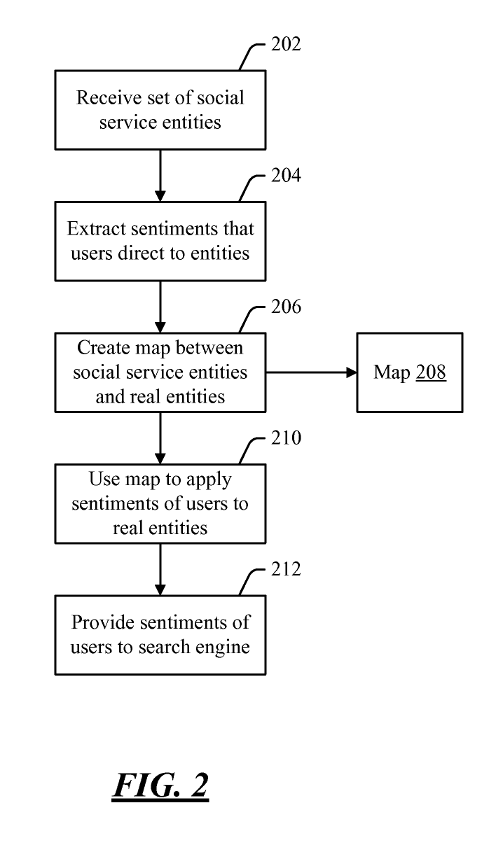

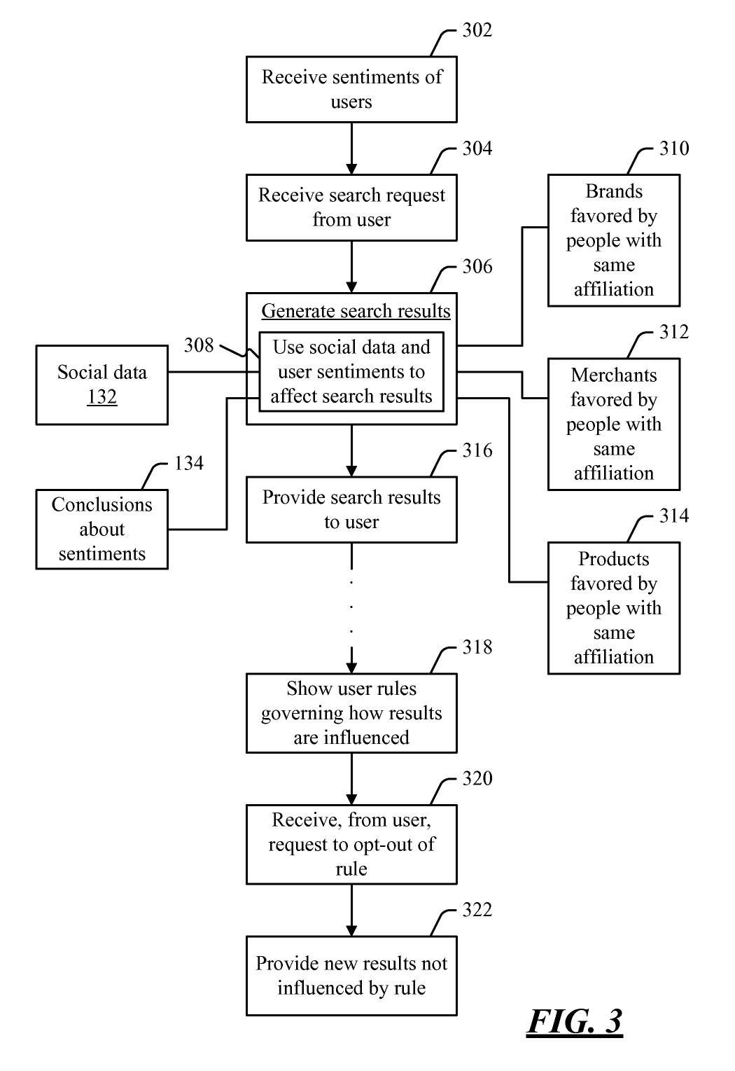

FIG. 2 shows an example process in which sentiments may be directed to real entities. Before turning to a description of FIG. 2, it is noted that the flow diagrams contained herein (both in FIG. 2 and in FIG. 3) are described, by way of example, with reference to components shown in FIG. 1, although these processes may be carried out in any system and are not limited to the scenario shown in FIG. 1. Additionally, each of the flow diagrams in FIGS. 2 and 3 shows an example in which stages of a process are carried out in a particular order, as indicated by the lines connecting the blocks, but the various stages shown in these diagrams can be performed in any order, or in any combination or sub-combination.

At 202, the process may receive a set of social service entities. “Social service entities” may refer to entities as they are known on a social service—e.g., the Facebook page(s) for Microsoft, Twitter-style hashtags referring to a particular brand of car, etc. As noted above, a given real entity may have one or more names within a given social service, including both official and/or unofficial names. At 204, sentiments that users directed to the entities on the social service are extracted from information on the social service. In one example, users are given the opportunity to provide structured information, such as when users “like” a page by using a “like button.” In another example, users provide unstructured information relating to an entity—e.g., by leaving a text comment. When information is structured (as in the case of “likes”), extracting the sentiment may be simple; when information is unstructured as in the case of text comments, extracting the sentiment may be more complicated. However, both situations are examples of extracting user sentiments, as performed at 204.

At 206, a map 208 may be created between social service entities and real entities. As explained above, a given entity may correspond to several different entities on a social service. For example, PQR Motors may have an official page on Facebook, and several unofficial pages created by users. Users can “like” or comments on these pages as if they were separate entities, although all such pages map to the single “real” entity PQR Motors. Thus, map 208 is created in order to define the relationship between entities on a social service (such as pages) and the “real” entities that those pages represent.

At 210, the map may be used to apply, to real entities, the sentiments that users directed to social service entities. For example, the user named Joe might “like” the official PQR Motors page on Facebook, and the user named Susan might leave the comment “PRQ Motors cars get terrible gas mileage” on an unofficial PQR Motors page on Facebook. Both such sentiments can be extracted at 204, and—using map 208—both such sentiments can be treated as having been directed to PRQ Motors at 210.

At 212, the sentiments of users may be provided to a search engine, so that the search engine can use the sentiments to affect or influence search results.

An example process in which a social service uses the sentiments to affect or influence search results is described in connection with FIG. 3.

At 302, sentiments of users are received by a search engine. At 304, a search request may be received from a user. The search request may be for a product—e.g., the query could be “tablet computer”, “straight edge razor”, “4-door sedan”, etc. At 306, the search engine may generate search results based on the query. The process of generating search results at 306 may include various sub-actions, such as using social data 132 and conclusions about user sentiments (block 134) to affect search results (at 308).

There are various ways to use social data and/or user sentiments to affect or influence search results. In one example, social data 132 defines relationship among users (e.g., who is friends with whom, who follows whom, etc.), and may also indicate people's affiliations with schools, workplaces, interests, groups, etc. The search algorithm may infer that people who have the same affiliations might have similar tastes. For example, people who have the same affiliations might favor the same brands (block 310), the same merchants (block 312), or the same products (block 314). For example, it might be the case that people who went to Stanford University have a predilection for a particular brand of laptop, so, in response to a search request for “laptop” from a Stanford graduate, the search engine may put models of that brand on top. Or, people who work for Microsoft Corporation might have a predilection for a particular retailer, so, in response to a search request from a Microsoft employee, the search engine might put products offered by a particular retailer on top. The extent to which affiliations influence people's tastes (and, therefore, the extent to which the search engine takes people's affiliations into account when ranking search results) may be determined by a machine-learning process described below. It is noted that, in one example, the algorithm uses the sentiments of people who have the same affiliations as the user who submitted the query, even if the sentiments of the user himself are not being used. (However, it is noted that the subject matter herein covers scenarios in which the search engine is not tuned through a machine-learning process, and even covers situations in which the search engine's assumptions about how affiliations affect a person's taste are incorrect.)

In one example, people's actions in response to search results could be used to tune the search algorithm. For example, if the search engine chooses the top result for the search “laptop” in favor of a particular model based on the fact that people who went to the searcher's college seem to like that model, it can be determined whether the user did or did not click on the top choice. Whether users did, or did not, click the top choice provides a set of positive and negative examples, which can be provided to a machine learning algorithm as training data. In this way, machine learning can be used to tune the search algorithm as to how much significance to assign to affiliations when performing certain types of searches. For example, the algorithm might determine that people's choice of laptop is very strongly related to the college they attended, but not to their workplace. Or, it might determine that school affiliation is very strongly related to a person's choice of cars, but not to their choice of food. A search engine trained on this type of data can determine how much to affect the search results based on the sentiments of users who are affiliated to the searcher.

Once search results have been created, the search results may be provided to a user (at 316).

At some point in time, the results governing how affiliations influence search results may be shown to a user (at 318). For example, if a user performs a search for “laptop” and is shown results, the user might be shown rules such as “favor laptops liked by people who went to your school.” The user might decide that he agrees or disagrees with this rule. For example, the user might believe that school affiliation has nothing to do with laptop choice (even if data collected by a search engine, and processed by a machine learning algorithm, suggests that there is a correlation between school affiliation and laptop choice). Thus, the user might decide to opt-out of that rule, and a request for such an opt-out might be received at 320. The search engine may then follow the user's request—e.g., by providing new search results to the user at 322, where the new search results are not influenced by the sentiments of people who are affiliated with the user.

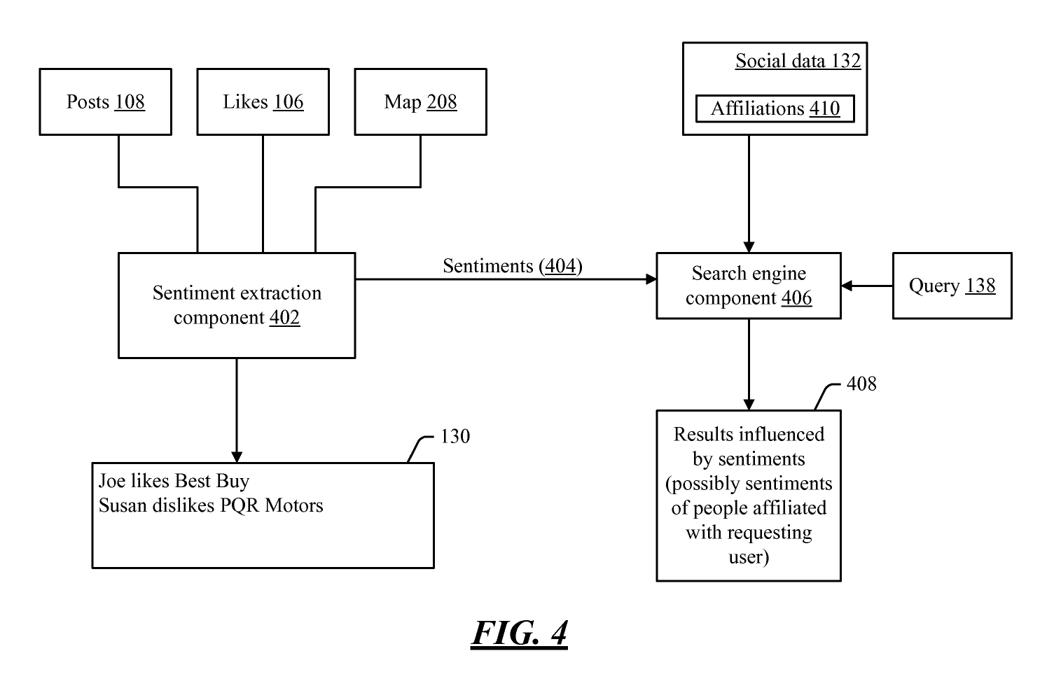

FIG. 4 shows an example system in which sentiments may be extracted and used to affect search results. A sentiment extraction component 402 may create an association between user sentiments and real entities (block 130). Sentiment extraction component 402 may create this association using social network posts 108, “like” data 106, and map 208. As described above, posts 108 may be unstructured data such as text comments, “like” data may be structured data such as users' using the “like” button on Facebook, and map 208 may be data that defines a relationship between entities on a social network (e.g., various official and unofficial pages for a brand) and real entities (e.g., the brand itself). Sentiment extractor may provide the extracted sentiments 404 to a search engine component 406.

Search engine component 406 may receive a query 138 from a user, and may provide results 408 based on the query. When forming the results, search engine component 406 may use sentiments 404 and social data 132 (which may include data on people's affiliations 410). For example, search engine component 406 may have an algorithm that states that people who went to the same school tend to like the same brands of laptop. Thus, search engine component 406 may use social data 132 to determine who went to the same school as the user who submitted query 138, and may then use sentiments 404 to determine what laptops tend to be liked by people who went to that school. Once search engine component 406 has determined what laptops are liked by people who went to a particular school, search engine component 406 may create results 408 that are influenced by the sentiments—e.g., a model or brand of laptop that is favored by graduates of the same school attended by the submitter of query 138 may be floated to the top of the search results, even if a different model might have been placed on top without the influence of school affiliation.

Sentiment extraction component 402 and search engine component 406 may both be implemented through hardware and/or software.

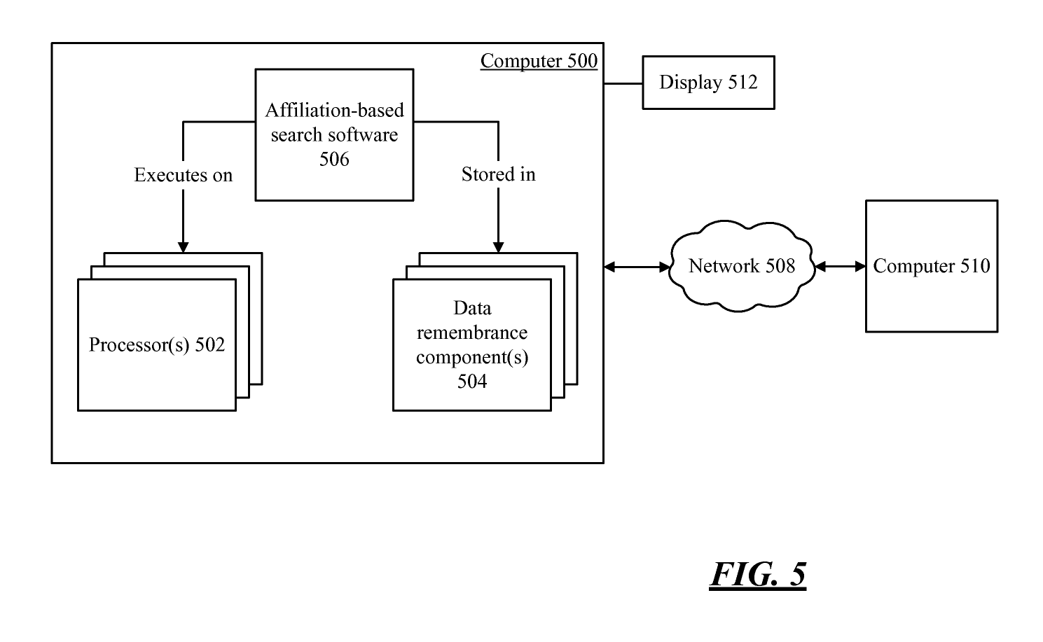

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is affiliation-based search software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium that stores executable instructions for using information to affect search results, the executable instructions, when executed by a computer, causing the computer to perform acts comprising:
receiving a set of social service entities in a social service;
extracting, from said social service, sentiments that users of said social service direct to said social service entities;
creating a map between said social service entities and real entities;
using said map to apply sentiments of said users to said real entities; and
providing said sentiments of said users to a search engine that receives a search request from a first user and uses said sentiments to affect results of a search performed based on said search request.

2. The computer-readable medium of claim 1, said social service maintaining data on said users' affiliations, said search engine receiving said search request from said first user who is one of said users, and using sentiments of other ones of said users who have a same affiliation as said first user to affect said results.

3. The computer-readable medium of claim 2, said search request being for a product, said search engine using product predilections of said other ones of said users to influence said results in favor of said product based on said other ones of said users having expressed a predilection for said product, and not based on said first user's having expressed a predilection for said product.

4. The computer-readable medium of claim 2, said search request being for a product, said search engine using product predilections of said other ones of said users to influence said results in favor of a brand of said product based on said other ones of said users having expressed a predilection for said brand, and not based on said first user's having expressed a predilection for said brand.

5. The computer-readable medium of claim 2, said search engine showing said first user a rule governing how sentiments of said other ones of said users are used to affect said results.

6. The computer-readable medium of claim 5, said acts further comprising:
receiving, from said first user, a request not to use said rule; and
following said request not to use said rule by creating new search results that are not affected by said rule.

7. The computer-readable medium of claim 1, said entities in said social service including a merchant, said first user having indicated a predilection for said merchant, said search engine receiving a search request for a product from said first user and using said first user's predilection for said merchant to influence said results in favor of products provided by said merchant, said first user being one of said users.

8. The computer-readable medium of claim 1, said entities in said social service including a brand of product, said first user having indicated a predilection for said brand, said search engine a receiving search request for a product from said first user and using said first user's predilection for said brand to influence said results in favor of products of said brand, said first user being one of said users.

9. A method of providing search results, the method comprising:
using a processor to perform acts comprising:
extracting, from a social service, sentiments that users of said social service direct to first entities on said social service;
creating a map between said first entities on said social service and second entities to which said first entities correspond, said second entities being real entities;
extracting sentiments of said users toward said first entities from comments and flags on said social service, to marshal a set of extracted sentiments;
using said map to apply said extracted sentiments to said second entities;
receiving, from a first user, a request for a product search, said first user being one of said users;
generating results for said product search by using sentiments applied to said second entities to influence said results; and
providing said results to said first user.

10. The method of claim 9, said acts further comprising:
maintaining data on said users' affiliations; and
using sentiments of users other than said first user who have a same affiliation as said first user to influence said results.

11. The method of claim 10, said affiliation comprising a school that said first user, and said users other than said first user, attend or attended.

12. The method of claim 10, said affiliation comprising an employer for whom said first user, and said users other than said first user, work or worked.

13. The method of claim 10, said sentiments of said users other than said first user comprising a predilection for a merchant, influencing of said results being based on said users other than said first user having expressed a predilection for said merchant, and not based on said first user's having expressed a predilection for said product, said results being influenced in favor of products provided by said merchant.

14. The method of claim 10, said sentiments of said users other than said first user comprising a predilection for a brand, influencing of said results being based on said users other than said first user having expressed a predilection for said brand, and not based on said first user's having expressed a predilection for said brand, said results being influenced in favor of products of said brand.

15. The method of claim 10, said acts further comprising:
showing said first user a rule governing how sentiments of said users other than said first user are used to influence said results.

16. The method of claim 15, said acts further comprising:
receiving, from said first user, a request not to use said rule; and
following said request not to use said rule by creating new search results that are not affected by said rule.

17. A system for providing search results, the system comprising:
a memory;
a processor;
a sentiment extraction component that is stored in said memory, that executes on said processor, that receives a set of social service entities in a social service, that extracts from said social service, sentiments that users of said social service direct to real entities associated with said social service entities, that creates a map between said social service entities and said real entities, and that uses said map to apply sentiments of said users to said real entities; and
a search engine component that is stored in said memory, that executes on said processor, that receives, from a first user, a request for a product search, that generates results for said product search by using sentiments applied to said real entities to influence said results, and that provides said results to said first user, said first user being one of said users.

18. The system of claim 17, said social service maintaining data on said users' affiliations, said search engine component using sentiments of users who have a same affiliation as said first user to influence said results.

19. The system of claim 18, said sentiments of said users who have a same affiliation as said first user comprising a predilection for a merchant, said results being influenced in favor of products provided by said merchant based on said users, other than said first user, having expressed a predilection for said merchant, and not based on said first user having expressed a predilection for said merchant.

20. The system of claim 18, said search engine component showing to said first user a rule that governs how sentiments of users other than said first user are used to influence said results, said search engine component receiving, from said first user, a request not to use said rule, said search engine component following said request by creating new search results that are not affected by said rule.
